(19) United States
(12) Patent Application Publication
(10) Pub. No.: US 2018/0213584 A1
(43) Pub. Date: Jul. 26, 2018

(54) DATA TRANSMISSION METHOD, DEVICE AND SYSTEM, AND COMPUTER STORAGE MEDIUM

(71) Applicant: ZTE CORPORATION, Shenzhen (CN)

(72) Inventor: Li Yang, Shenzhen (CN)

(21) Appl. No.: 15/743,066

(22) PCT Filed: Mar. 1, 2016
(86) PCT No.: PCT/CN2016/075260

§ 371 Date: Jan. 9, 2018

(30) Foreign Application Priority Data
Jul. 9, 2015 (CN) 201510400353.5

(51) Int. Cl. H04W 76/15; H04W 72/04; H04W 76/27; H04W 16/14; H04W 88/06

(52) U.S. Cl. CPC H04W 76/15; H04W 72/0406; H04W 84/12; H04W 16/14; H04W 88/06; H04W 76/27

(57) ABSTRACT

Disclosed in the present disclosure are a data transmission method, device, a system, and a computer storage medium. The method is applied to a communication system including a terminal and a network device, and the terminal is provided with at least two WLAN communication elements capable of performing WLAN communication and next generation WLAN communication. The method includes: transmitting, by the terminal, communication parameters of each of the WLAN communication elements to the network device; and controlling, by the network device, each of the WLAN communication elements according to the communication parameters to establish at least two aggregated WLAN links (AWL) with accessible access points (AP) respectively, where each of the AWL can be configured to carry data and to stop carrying data, and can also be maintained, reconfigured and deleted separately.

### TECHNICAL FIELD

The present disclosure relates to a mobile communication technology, and particularly to a data transmission method, a device, a system and a computer storage medium.

### BACKGROUND

Along with continuous increase and future exponential increase of number of subscribers of a mobile communication operating company and a mobile service volume of voice data of the subscribers and the like, an input and deployment scale of mobile communication network infrastructures is also required to be correspondingly enlarged to make a wireless coverage breadth and depth and a system communication capacity meet increasing objective requirements of the subscribers.

For example, most of mobile communication operating companies in Europe successively deployed mobile communication systems of three different Radio Access Technology (RAT) systems in the history: a Global System of Mobile communication (GSM), a Universal Mobile Telecommunications System (UMTS) and a Long Term Evolution (LTE) system, and the systems all adopt systems in a 3rd Generation Partnership (3GPP) communication system family. These cellular mobile systems all work on licensed carriers in licensed spectrums. In order to further enhance functions of mobile communication networks and expand system capacities, the mobile communication operating companies also widely deploy a large number of, for example, Wireless Local Area Network (WLAN) systems, in an Institute of Electrical and Electronics Engineers (IEEE) communication system family as effective and low-cost wireless capacity supplements, and the WLAN systems are being evolved to next-generation High Efficiency WLAN (HEW) systems. Although, for example, a cellular mobile network of a 3GPP system may not be independently constructed with high performance, a WLAN system has high market vitality and competitiveness because its physical implementation requires a far simpler technology and lower cost than a 3GPP system and it works on a free unlicensed carrier, with a larger bandwidth, in an unlicensed spectrum.

Each of the above mobile communication system is basically formed by the following main logical network element nodes: a terminal-User Equipment (UE)/Station (STA) supporting a one-RAT single-mode or multi-RAT multi-mode system, a Radio Access Network (RAN)/Access Point (AP), a Core Network (CN), a network manager-Operation and Maintenance Center (OMC), a bearer network-TBN and the like. For example: a network side of a UMTS is formed by a CN logical node unit-Mobile Switching Center (MSC)/Media Gateway (MGW)/Serving General Packet Radio Service (GPRS) Support Node (SGSN)/Gateway GPRS Support Node (GGSN), an RAN logical node unit-Node B (NodeB)/RNC and ground interfaces-Iu, Iub, Iur and the like normalized by a 3GPP standard therebetween. A network side of an LTE system is formed by a CN logical node unit-Mobility Management Entity (MME)/Serving Gateway (SGW)/Packet Data Network (PDN) Gateway (PGW)/Internet Protocol (IP) Multimedia Subsystem (IMS), an RAN logical node unit-evolved Node B (eNB) and ground interfaces-S1, X2 and the like therebetween. A network system of a WLAN system is formed by a radio control unit-Access Controller (AC), a radio access unit-AP and the like.

Due to long-term evolution and coexistence deployment and simultaneous provision of radio access and data transmission service of the multiple wireless communication systems (Multi-RAT), for enhancing mobility performance between the systems, enhancing a Key Performance Indicator (KPI) experience of a user in mobile communication, reducing development and maintenance cost of software and hardware and facilitating operation and maintenance management of operating companies over a “Multi-RAT large network”, the 3GPP has developed and formulated standardized technologies of multiple versions to couple the various wireless communication systems to different extents/levels to work to form so-called intersystem joint interoperations.

As shown in a network architecture example in FIG. 1: a WLAN AP and three main 3GPP RAN units are connected to the same aggregated CN, and operating companies may more flexibly collaborate to transmit information about a capability/configuration/state between different RATs, formulate reasonable mobile strategies and serve UE with the most appropriate RAT base stations/cells according to requirements of a Quality of Service (QOS) characteristic of a service and a resource state. Enhancing joint interoperations between different RATs has the following advantages: different RATs may better develop advantages and characteristics of their own systems, different RATs may more flexibly share wireless communication loads of a vast number of users in a balanced manner, and different RATs may form dynamic complements of hardware resources, wireless coverage and capacities, thereby bringing a higher KPI to the whole “Multi-RAT large network” and creating better mobile communication experiences and feelings for the vast number of users.

According to an existing disclosed technology, a terminal with a WLAN/3GPP multi-mode capability may be kept in a communication connection/data transmission state with a WLAN AP and a base station of a certain RAT in a 3GPP family. A joint interoperation of WLAN and LTE systems will be described below as an example in a centralized manner (a principle is substantially applicable to a joint interoperation of other RATs). For example, a certain terminal with a WLAN/LTE dual-mode capability is covered by wireless signals of both WLAN and LTE cells, the terminal establishes a Radio Resource Control (RRC) connection with an LTE network at first at a certain moment, and then performs bidirectional data transmission on a certain IP service stream A, and later, a user initiates a new IP service stream B. In a manual User Preference (UP) mode, the terminal finds a coverage signal of a WLAN and completes necessary AP network access associated authentication and registration Attach (this process is called as WLAN selection registration), then an aggregated CN may migrate the IP service stream B into the WLAN system where the terminal has been successfully registered before according to a certain strategy rule and upper-layer protocol signaling, the IP service stream A of the terminal is still born in the LTE network, and the IP service stream B is born in the WLAN (this process is called as WLAN data offloading). Such a basic process is shown in FIG. 2 and FIG. 3.

Till a 3GPP Release-13 (Rel-13), there have been multiple basic mechanisms for coupling joint interoperations of WLAN-LTE, and besides manual UP in the above example, there are also mechanisms of Enhanced Access Network Discovery Selection Function (eANDSF), Enhanced RAN Rule Base Interworking (eITW), LTE WLAN Aggregation (LWA) and the like. Except the LWA mechanism, all of the other mechanisms are required to release original IP Flows/Data Radio Bearers (DRBs) in an LTE network dependent on UE and establish/maintain WLAN connections with target APs through WLAN air interface signaling to implement migration and offloading of IP Flows bearing service data of users on a CN side.

An LWA mechanism adopting a tight coupling manner may not cause migration of IP Flows on a CN side, but only transmits part of user-plane data born by IP Flows/DRB s in an LTE network through mutually tightly coupled target APs, and an anchor-Macro eNB (MeNB) on a radio access side controls addition/reconfiguration/deletion of the target APs and forwarding, recovery and the like of related offloading data. It may be understood that: the MeNB (main base station node, also called as the anchor) is a centralized control node of all APs in an LWA working mode, the basic process is shown in FIG. 4 and FIG. 5, the MeNB transmits and forwards an IP service stream B selected for tight coupling offloading to the tightly coupled AP through an interface between the MeNB and the target AP, and then the AP performs uplink and downlink IP data packet transmission at a WLAN air interface. Therefore, the offloaded IP service stream B is not controlled by a CN but still the anchor MeNB.

In the past, the 3GPP extensively discussed the above mechanisms on the basis of UE with a “single-AP connection capability”, that is, specific UE may perform associated authentication with only one target AP at a certain specific moment, and may simultaneously perform data transmission through only one WLAN air interface link. The UE with the “single-AP connection capability” is usually internally configured with a set of WLAN related radio frequency baseband resources, and such a physical limit to a capability configuration of the UE has the following shortcomings.

1: If fewer 3GPP system related resources are configured on a network side of an operating company (for example: few and narrow LTE licensed carriers are deployed and there are few 3GPP system related Baseband Unit (BU) processing resources) but more WLAN related resources are deployed on the network side (for example—many and wide WLAN unlicensed carriers are deployed and there are many WLAN system related BU processing resources), Mismatch in a capability configuration proportion of the UE with the “single-AP connection capability” and the network side is inevitable, which makes part of the 3GPP related capability resources in the UE idle, and since the UE has only one set of WLAN resource module, redundant WLAN resources of the network side may not be fully utilized.

2: Mobility of the UE causes reselection and reassociation/reauthentication of the target AP, and due to the limit of the only one WLAN resource module, the UE with the “single-AP connection capability” may usually have a greater transmission delay and a data-plane transmission interruption in a mobility process (although the WLAN system has a fast Base Station Subsystem (BSS) transition or 802.11r amendment enhancement mechanism). This may bring more control-plane signaling redundancy Overhead and reduction in a user experience in a scenario where APs are deployed more densely.

3: Since a single set of WLAN resource module always has a limit of a maximum supported bandwidth (for example, present 160 MHz), it may still not maximally integrate WLAN resources provided by the network side as many as possible and achieve higher user throughput and peak rate.

### SUMMARY

In order to solve the existing technical problem, embodiments of the disclosure provide a data transmission method, a device, a system and a computer storage medium.

The embodiments of the disclosure provide a data transmission method, which may be applied to a communication system, the communication system including a terminal and network equipment, the terminal being provided with at least two WLAN communication elements which support WLAN communication and next-generation WLAN communication respectively, the method including the following actions.

The terminal sends communication parameters of the WLAN communication elements to the network equipment.

The network equipment controls the WLAN communication elements to establish at least two Aggregated WLAN Links (AWLs) with accessible APs respectively according to the communication parameters, where each of the AWLs is arranged to bear data, and each of the AWLs may not only bear the data but also stop bearing the data, and may further be independently maintained, reconfigured and deleted.

According to an embodiment, the method may further include the following actions.

The terminal detects a state of each of the WLAN communication elements in a polling manner, and when it is detected that one of the WLAN communication elements is in an idle or available state, sends an AWL establishment request to the network equipment.

The network equipment controls the WLAN communication element in the idle or available state to establish an AWL with an accessible AP according to the AWL establishment request.

According to an embodiment, the method may further include the following actions.

The network equipment detects the state of each of the WLAN communication elements in the polling manner on the basis of internally stored communication context information of the terminal, and when it is detected that one of the WLAN communication elements is in the idle or available state, controls the WLAN communication element in the idle or available state to establish an AWL with an accessible AP.

According to an embodiment, the WLAN communication elements may support an LWA mechanism.

Correspondingly, the action of sending, by the terminal, the communication parameters of the WLAN communication elements to the network equipment may include the following action.

The terminal reports the communication parameters of the WLAN communication elements to the network equipment as required through LTE or evolved system air interface RRC signaling.

According to an embodiment, the action of controlling the WLAN communication elements to establish at least two AWLs with the accessible APs respectively may include the following actions.

The network equipment configures strategy criterion parameters related to LWA for the WLAN communication elements in the idle or available state through RRC dedicated signaling.

The accessible APs are selected according to the received communication parameters of the WLAN communication elements.

Associated connections are formed between the selected accessible APs and the corresponding WLAN communication elements in the idle or available state respectively, to complete specified WLAN access authentication and registration to establish the AWLs.

According to an embodiment, the method may further include the following actions.

The network equipment coordinates data offloading bearing conditions of the AWLs on the basis of at least one of internally stored communication context information parameters or the communication parameters fed back by the terminal to enable the AWLs to bear offloaded data in an independent or collaborative manner.

The embodiments of the disclosure provide a data transmission method, which may be applied to a terminal, the terminal being provided with at least two WLAN communication elements which support WLAN communication and next-generation WLAN communication respectively. The method include the following actions.

Communication parameters of the WLAN communication elements are sent to network equipment to enable the network equipment to control the WLAN communication elements to establish at least two AWLs with accessible APs respectively according to the communication parameters.

Each of the WLAN communication elements is enabled to establish the at least two AWLs with the accessible AP under control of the network equipment, where each of the AWLs may be arranged to bear data, and each of the AWLs may not only bear the data but also stop bearing the data, and may further be independently maintained, reconfigured and deleted.

According to an embodiment, the method may further include the following actions.

A state of each of the WLAN communication elements is detected in a polling manner, and when it is detected that one of the WLAN communication elements is in an idle or available state, an AWL establishment request is sent to the network equipment to enable the network equipment to control the WLAN communication element in the idle or available state to establish an AWL with an accessible AP according to the AWL establishment request.

According to an embodiment, the WLAN communication elements may support an LWA mechanism.

Correspondingly, the action of sending the communication parameters of the WLAN communication elements to the network equipment may include the following actions.

The communication parameters of the WLAN communication elements are reported to the network equipment as required through LTE or evolved system air interface RRC signaling.

The embodiments of the disclosure provide a data transmission method, which may be applied to network equipment. The method includes the following actions. Communication parameters of at least two WLAN communication elements provided in a terminal is received from the terminal, the WLAN communication elements supporting WLAN communication and next-generation WLAN communication.

The WLAN communication elements are controlled to establish at least two AWLs with accessible APs respectively according to the communication parameters, where each of the AWLs may be arranged to bear data, and each of the AWLs may not only bear the data but also stop bearing the data, and may further be independently maintained, reconfigured and deleted.

According to an embodiment, the method may further include the following actions.

The WLAN communication elements in an idle or available state in the terminal are controlled to establish the AWLs with the accessible APs according to an AWL establishment request sent by the terminal, states of the WLAN communication elements being detected by the terminal in a polling manner.

According to an embodiment, the method may further include the following actions.

The state of each of the WLAN communication elements is detected in the polling manner on the basis of internally stored communication context information of the terminal, and when it is detected that one of the WLAN communication elements is in the idle or available state, the WLAN communication element in the idle or available state are controlled to establish an AWL with an accessible AP.

According to an embodiment, the action of controlling the WLAN communication elements to establish the at least two AWLs with the accessible APs may include the following actions.

Strategy criterion parameters related to LWA are configured for the WLAN communication elements in the idle or available state through RRC dedicated signaling.

The accessible APs are selected according to the received communication parameters of the WLAN communication elements.

Associated connections are formed between the selected accessible APs and the corresponding WLAN communication elements in the idle or available state respectively, to complete specified WLAN access authentication and registration to establish the AWLs.

According to an embodiment, the method may further include the following actions.

Data offloading bearing conditions of the AWLs are coordinated on the basis of at least one of internally stored communication context information parameters or the communication parameters fed back by the terminal to enable the AWLs to bear offloaded data in an independent or collaborative manner.

The embodiments of the disclosure provide a terminal, which may be applied to a communication system, the communication system further including network equipment, the terminal being provided with at least two WLAN communication elements which support WLAN communication and next-generation WLAN communication respectively. The terminal includes a sending unit and a processing unit.

The sending unit is arranged to send communication parameters of the WLAN communication elements to the network equipment to enable the network equipment to control the WLAN communication elements to establish at least two AWLs with accessible APs respectively according to the communication parameters.

The processing unit is arranged to enable the WLAN communication elements to establish the at least two AWLs with the accessible APs under control of the network equipment, where each of the AWLs may be arranged to bear data, and each of the AWLs may not only bear the data but also stop bearing the data, and may further be independently maintained, reconfigured and deleted.

According to an embodiment, the terminal may further include a detection unit, and the detection unit may be arranged to detect a state of each of the WLAN communication elements in a polling manner, and when it is detected that one of the WLAN communication elements is in an idle or available state, send an AWL establishment request to the network equipment to enable the network equipment to control the WLAN communication element in the idle or available state to establish an AWL with an accessible AP according to the AWL establishment request.

The processing unit may further be arranged to enable the WLAN communication elements to establish the AWLs with the accessible APs under control of the network equipment.

According to an embodiment, the WLAN communication elements may support an LWA mechanism.

The sending unit may be arranged to report the communication parameters of the WLAN communication elements to the network equipment as required through LTE or evolved system air interface RRC signaling.

The embodiments of the disclosure provide network equipment, which may be applied to a communication system, the communication system further including a terminal, the terminal being provided with at least two WLAN communication elements which support WLAN communication and next-generation WLAN communication respectively. The network equipment includes a receiving unit and a control unit.

The receiving unit is arranged to receive communication parameters of the WLAN communication elements from the terminal.

The control unit is arranged to control the WLAN communication elements to establish at least two AWLs with accessible APs respectively according to the communication parameters, where each of the AWLs may be arranged to bear data, and each of the AWLs may not only bear the data but also stop bearing the data, and may further be independently maintained, reconfigured and deleted.

According to an embodiment, the control unit may further be arranged to control the WLAN communication elements in an idle or available state in the terminal to establish the AWLs with the accessible APs according to an AWL establishment request sent by the terminal, states of the WLAN communication elements being detected by the terminal in a polling manner.

According to an embodiment, the control unit may further be arranged to detect the state of each of the WLAN communication elements in the polling manner on the basis of internally stored communication context information of the terminal, and when it is detected that one of the WLAN communication elements is in the idle or available state, control the WLAN communication element in the idle or available state to establish an AWL with an accessible AP.

According to an embodiment, the control unit may be arranged to configure strategy criterion parameters related to LWA for the WLAN communication elements in the idle or available state through RRC dedicated signaling;

select the accessible APs according to the received communication parameters of the WLAN communication elements; and

form associated connections between the selected accessible APs and the corresponding WLAN communication elements in the idle or available state respectively, to complete specified WLAN access authentication and registration to establish the AWLs.

According to an embodiment, the control unit may coordinate data offloading bearing conditions of the AWLs on the basis of at least one of internally stored communication context information parameters or the communication parameters fed back by the terminal to enable the AWLs to bear offloaded data in an independent or collaborative manner.

The embodiments of the disclosure provide a communication system, which may include a terminal and network equipment, where the terminal may be provided with at least two WLAN communication elements, and the WLAN communication elements may support WLAN communication and next-generation WLAN communication respectively.

The terminal may be arranged to send communication parameters of the WLAN communication elements to the network equipment.

The network equipment may be arranged to control the WLAN communication elements to establish at least two AWLs with accessible APs respectively according to the communication parameters, where each of the AWLs may be arranged to bear data, and each of the AWLs may not only bear the data but also stop bearing the data, and may further be independently maintainable, reconfigurable and delectable.

According to an embodiment, the terminal may further be arranged to detect a state of each of the WLAN communication elements in a polling manner, and when it is detected that one of the WLAN communication elements is in an idle or available state, send an AWL establishment request to the network equipment.

The network equipment may further be arranged to control the WLAN communication elements in the idle or available state to establish the AWLs with the accessible APs according to the AWL establishment request.

The embodiments of the disclosure provide a computer storage medium, which may include a set of instructions, the instructions being executed to enable at least one processor to execute the data transmission method for a terminal side or execute the data transmission method for a network equipment side.

From the above, it can be seen that the embodiments of the disclosure are applied to the communication system, the communication system includes the terminal and the network equipment, the terminal is provided with the at least two WLAN communication elements, and the method includes the following actions. The terminal sends the communication parameters of the WLAN communication elements to the network equipment. The network equipment controls each of the WLAN communication elements to establish the at least two AWLs with the APs according to the communication parameters, the AWLs being arranged to bear the data. The embodiments of the disclosure may not only reduce control-plane signaling redundancies but also fully utilize network-side resources.

### BRIEF DESCRIPTION OF DRAWINGS

FIG. 1 is an architecture of joint interoperation coupling of WLAN/3GPP according to an embodiment of the present disclosure.

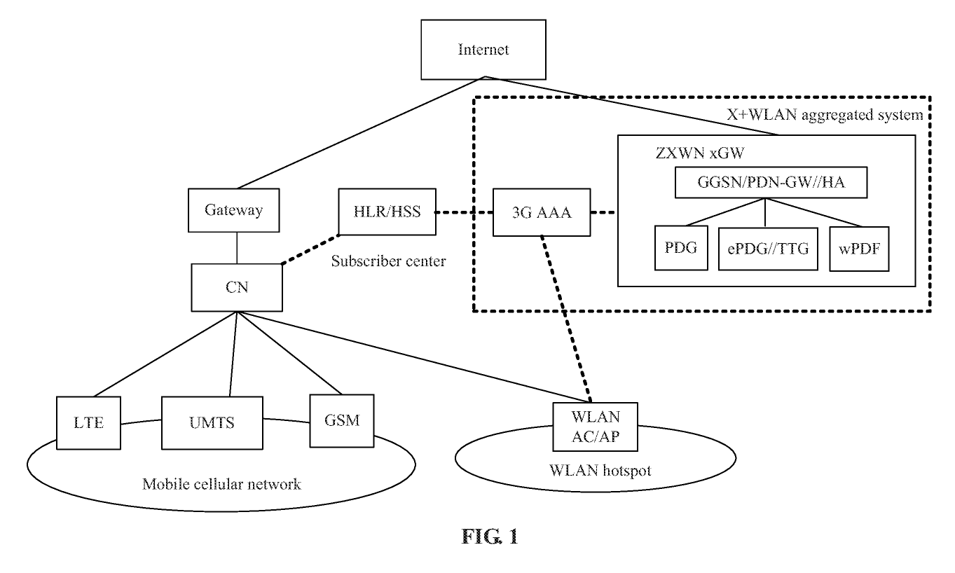

FIG. 2 is a schematic diagram of a state before IP Flow offloading to a WLAN AP node according to an embodiment of the disclosure.

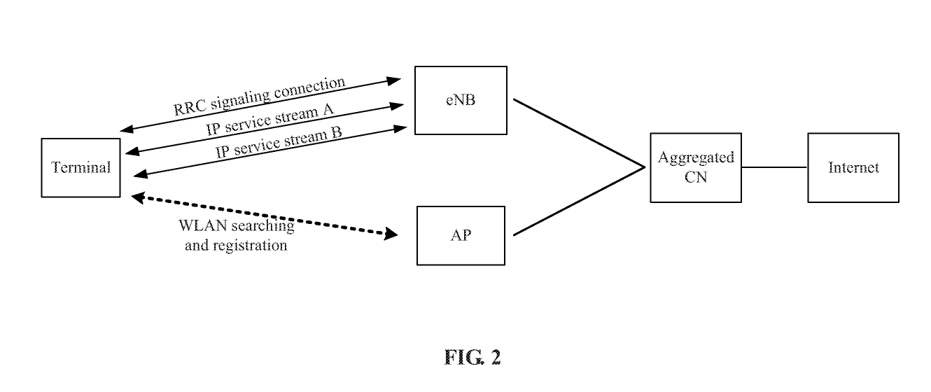

FIG. 3 is a schematic diagram of a state after IP Flow offloading to a WLAN AP node according to an embodiment of the disclosure.

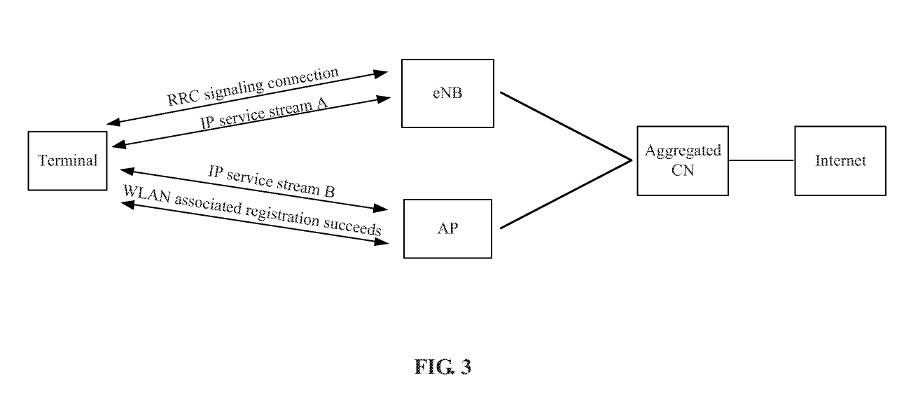

FIG. 4 is a schematic diagram of a state before tight coupling offloading to a WLAN AP node according to an embodiment of the disclosure.

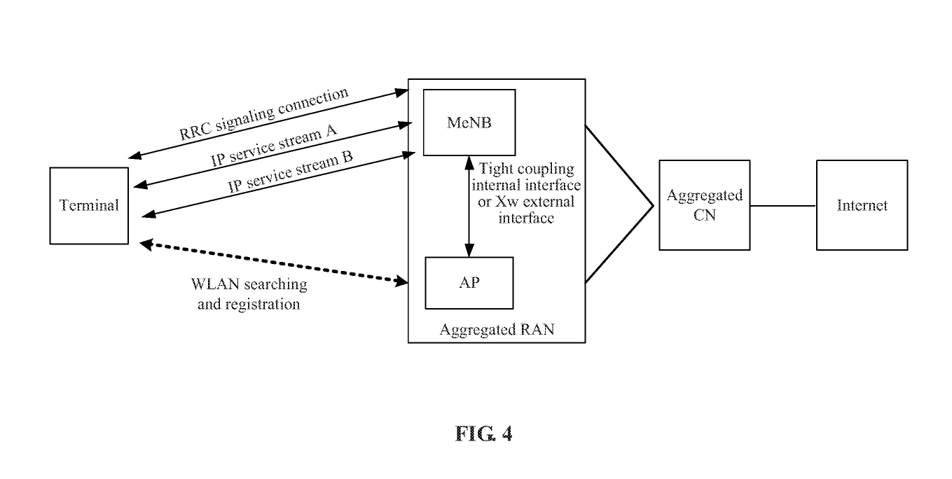

FIG. 5 is a schematic diagram of a state after tight coupling offloading to a WLAN AP node according to an embodiment of the disclosure.

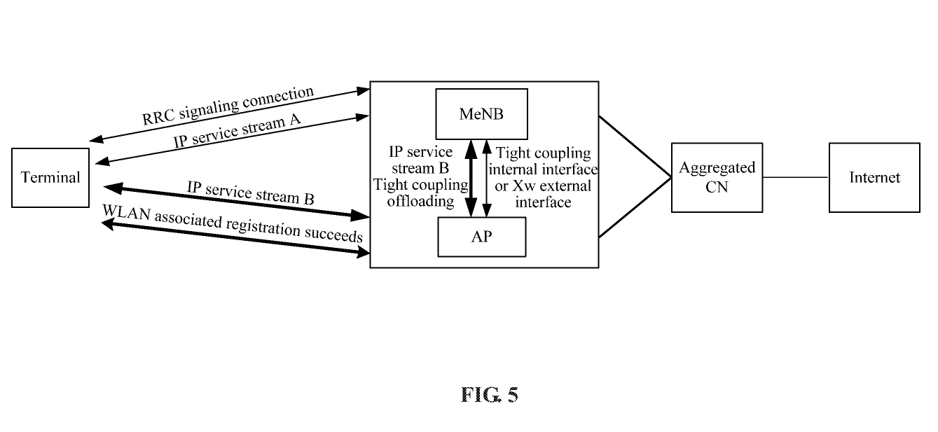

FIG. 6 is a flowchart of a first embodiment of a data transmission method according to the disclosure.

FIG. 7 is a flowchart of a second embodiment of a data transmission method according to the disclosure.

FIG. 8 is a schematic diagram of an application scenario according to a third embodiment of the disclosure.

FIG. 9 is a schematic diagram of an application scenario according to a fourth embodiment of the disclosure.

FIG. 10 is a structure diagram of an embodiment of a data transmission device according to the disclosure.

FIG. 11 is a structure diagram of an embodiment of another data transmission device according to the disclosure.

FIG. 12 is a structure diagram of an embodiment of another data transmission device according to the disclosure.

### DETAILED DESCRIPTION

It should be understood that multiple specific embodiments described here are adopted not to limit contents of the disclosure but only to explain the contents of the disclosure.

In each embodiment of the disclosure: a terminal is provided with at least two WLAN communication elements, and the terminal sends communication parameters of the WLAN communication elements to network equipment; and the network equipment controls the WLAN communication elements to establish at least two AWLs with APs respectively according to the communication parameters, the AWLs being arranged to bear data.

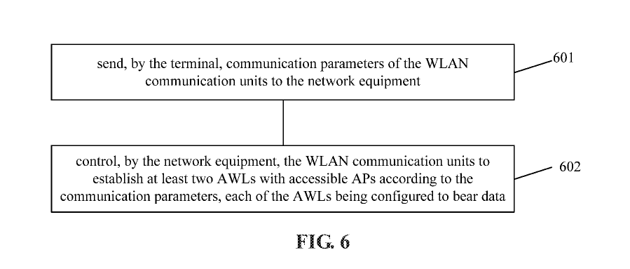

A first embodiment of the disclosure provides a data transmission method, which is applied to a communication system, the communication system including a terminal and network equipment, the terminal being provided with at least two WLAN communication elements which support WLAN communication and next-generation WLAN communication respectively, for example, HEW. As shown in FIG. 6, the method includes the following steps.

In Step 601, the terminal sends communication parameters of the WLAN communication elements to the network equipment.

In Step 602, the network equipment controls the WLAN communication elements to establish at least two AWLs with accessible APs respectively according to the communication parameters, where each of the AWLs is arranged to bear data, and each of the AWLs may not only bear the data but also stop bearing the data, and may further be independently maintained, reconfigured and deleted.

Here, it is important to note that the WLAN communication elements are also called as WLAN resource function modules or WLAN modules below.

The communication parameters include necessary parameters such as capability of whether supporting an LWA mechanism or not, a supported WLAN radio frequency band and a working bandwidth.

It is not hard to understand that the network equipment may include an MeNB, an aggregated CN and the like.

It can be understood that the terminal in the disclosure includes a mobile terminal.

In an embodiment, the method may further include the following actions.

The terminal detects a state of each of the WLAN communication elements in a polling manner, and when it is detected that one of the WLAN communication elements is in an idle or available state, sends an AWL establishment request to the network equipment.

The network equipment controls the WLAN communication element in the idle or available state to establish an AWL with an accessible AP according to the AWL establishment request.

In an embodiment, the method further includes the following actions.

The network equipment detects the state of each of the WLAN communication elements in the polling manner on the basis of internally stored communication context information of the terminal, and when it is detected that one of the WLAN communication elements is in the idle or available state, controls the WLAN communication element in the idle or available state to establish an AWL with an accessible AP.

In an embodiment, the WLAN communication elements support the LWA mechanism.

Correspondingly, the action of sending, by the terminal, the communication parameters of the WLAN communication elements to the network equipment includes the following actions.

The terminal reports the communication parameters of the WLAN communication elements to the network equipment, for example, the MeNB, as required through LTE or evolved system air interface RRC signaling.

In an embodiment, the action of controlling the WLAN communication elements to establish the at least two AWLs with the accessible AP may include the following actions.

The network equipment, for example, the MeNB, configures strategy criterion parameters related to LWA for the WLAN communication elements in the idle or available state through RRC dedicated signaling.

The accessible APs are selected according to the received communication parameters of the WLAN communication elements.

Associated connections are formed between the selected accessible APs and the corresponding WLAN communication elements in the idle or available state respectively, to complete specified WLAN access authentication and registration to establish the AWLs.

In an embodiment, the method further includes the following actions. The network equipment coordinates data offloading bearing conditions of the AWLs on the basis of at least one of internally stored communication context information parameters or the communication parameters fed back by the terminal to enable the AWLs to bear offloaded data in an independent or collaborative manner.

On such a basis, on a terminal side, a processing process mainly includes the following actions.

The communication parameters of the WLAN communication elements are sent to the network equipment to enable the network equipment to control the WLAN communication elements to establish the at least two AWLs with the accessible APs according to the communication parameters.

Each of the WLAN communication elements is enabled to establish the at least two AWLs with the accessible APs under control of the network equipment, where each of the AWLs may be arranged to bearer the data, and each of the AWLs may not only bear the data but also stop bearing the data, and may further be independently maintained, reconfigured and deleted.

According to an embodiment, processing on the terminal side may further include the following actions.

The state of each of the WLAN communication elements is detected in the polling manner, and when it is detected that one of the WLAN communication elements is in the idle or available state, the AWL establishment request is sent to the network equipment to enable the network equipment to control the WLAN communication element in the idle or available state to establish an AWL with an accessible AP according to the AWL establishment request.

In addition, when the WLAN communication elements support the LWA mechanism, the operation that the communication parameters of the WLAN communication elements are sent to the network equipment may include the following actions.

The communication parameters of the WLAN communication elements are reported to the network equipment according to the requirement through the LTE or evolved system air interface RRC signaling.

On a network equipment side, a processing process mainly includes the following actions.

The communication parameters of the WLAN communication elements are received from the terminal provided with the at least two WLAN communication elements which support WLAN communication and next-generation WLAN communication respectively.

Each of the WLAN communication elements is controlled to establish the at least two AWLs with the accessible APs according to the communication parameters, where each of the AWLs may be arranged to bear the data, and each of the AWLs may not only bear the data but also stop bearing the data, and may further be independently maintained, reconfigured and deleted.

Here, the action of controlling the WLAN communication elements to establish the at least two AWLs with the accessible APs may include the following actions.

The strategy criterion parameters related to LWA are configured for the WLAN communication elements in the idle or available state through the RRC dedicated signaling.

The accessible APs are selected according to the received communication parameters of the WLAN communication elements.

The associated connections are formed between the selected accessible APs and the corresponding WLAN communication elements in the idle or available state respectively, to complete specified WLAN access authentication and registration to establish the AWLs.

According to an embodiment, processing on the network equipment side may further include the following actions.

The WLAN communication element in the idle or available state in the terminal are controlled to establish an AWL with an accessible AP according to the AWL establishment request sent by the terminal, the states of the WLAN communication elements being detected by the terminal in the polling manner.

During a practical application, processing on the network equipment side may further include the following actions.

The state of each of the WLAN communication elements is detected in the polling manner on the basis of the internally stored communication context information of the terminal, and when it is detected that one of the WLAN communication elements is in the idle or available state, the WLAN communication element in the idle or available state is controlled to establish an AWL with an accessible AP.

In an embodiment, processing on the network equipment side may further include the following actions.

The data offloading bearing conditions of the AWLs are coordinated on the basis of at least one of the internally stored communication context information parameters or the communication parameters fed back by the terminal to enable the AWLs to bear the offloaded data in the independent or collaborative manner.

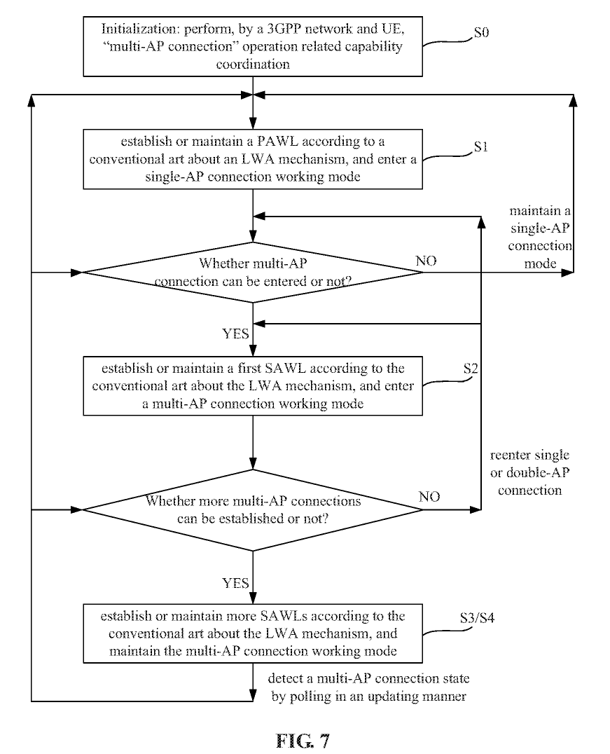

A second embodiment of the disclosure provides a data transmission method. Referring to FIG. 7, a main step flow involved in the embodiment is as follows.

In S0, a 3GPP network side (including: an aggregated CN, an aggregated RAN/AC/AP and the like) is initialized, and a “multi-AP connection related capability” of a terminal is acquired through air interface signaling, specifically including: a necessary parameter such as whether multiple sets of WLAN resource function modules equipped and configured in UE have a capability of supporting an LWA mechanism or not respectively, a supported WLAN radio frequency band and a working bandwidth, where the LWA mechanism is an existing 3GPP/WLAN tight coupling joint interoperation mechanism.

In S1, within a capability range of a certain set of WLAN resource function module in the UE, the 3GPP network side forms an associated connection at first between a certain node AP1 deployed on the network side and the set of WLAN resource function module in the UE according to an existing technical manner on the basis of an LWA mechanism supported by it to complete a necessary process of WLAN access authentication and registration and the like, and at this moment, the UE obtains an established Primary Aggregated WLAN Link (PAWL). After successful establishment, the 3GPP network side enables an MeNB, the AP1 and the UE to perform related air interface uplink and downlink data transmission on the basis of a conventional art about the LWA mechanism, that is, part of IP Flows in the UE or part of IP data packets in the IP Flows are offloaded and born or reversely de-loaded and de-born through the PAWL according to strategy criterion parameters and the like specified by the LWA mechanism.

In S2, after S1, if there is still a certain set of WLAN resource function module in an idle and unused state in the UE, within a capability range of the set of WLAN resource function module, the 3GPP network side forms an associated connection between a certain node AP2 deployed on the network side and the set of WLAN resource function module in the UE according to the existing technical manner under a certain condition on the basis of an LWA mechanism supported by it to complete the necessary process of WLAN access authentication and registration and the like, and at this moment, the UE obtains an established 1st Secondary Aggregated WLAN Link (SAWL). After successful establishment, the 3GPP network side enables the MeNB, the AP2 and the UE to perform related air interface uplink and downlink data transmission on the basis of a conventional art about the LWA mechanism, that is, part of IP Flows in the UE or part of IP data packets in the IP Flows are offloaded and born or reversely de-loaded and de-born through the 1st SAWL according to strategy criterion parameters and the like specified by the LWA mechanism. The IP Flows or IP data packets born by the 1st SAWL may come from user data streams, left on the 3GPP network side, of the UE, and may also be user data streams or IP data packets which have been offloaded and born by the PAWL.

In S3, similar to a processing principle and manner of S2, the 3GPP network side continues detecting a WLAN resource function module which has yet not been used in the UE, tries to form an associated connection between another node APx deployed on the network side and the set of WLAN resource function module in the UE according to the existing technical manner under a certain condition on the basis of an LWA mechanism supported by it to complete the necessary process of WLAN access authentication and registration and the like, and at this moment, the UE obtains more established 2nd/3rd/4th . . . SAWLs. After successful establishment, the 3GPP network side enables the MeNB, the APx and the UE to perform related air interface uplink and downlink data transmission on the basis of a conventional art about the LWA mechanism, that is, part of IP Flows in the UE or part of IP data packets in the IP Flows are offloaded and born or reversely de-loaded and de-born through more 2nd/3rd/4th . . . SAWLs according to strategy criterion parameters and the like specified by the LWA mechanism. The IP Flows born by the 2nd/3rd/4th . . . SAWLs may come from the user data streams, left on the 3GPP network side, of the UE, and may also be user data streams or IP data packets which have been offloaded and born by the PAWL and the 1st SAWL. A sequential recursion manner is adopted for the latter modules.

In S4, a stopping condition of the above sequential recursion processing is that: the 3GPP network side detects that all the WLAN resource function modules with LWA capabilities in the UE have been used, or for the UE, the 3GPP network side may temporally not provide any serving AP node to form an LWA associated connection with a certain WLAN resource function module in the UE any more, including the conditions that a signal coverage intensity and quality, wireless load, return bandwidth and the like of a WLAN AP do not meet access conditions, WLAN authentication and registration fails and the like. Along with passage of time, after condition states of the 3GPP network side and the UE change, Steps S1/2/3 will be re-executed, that is: the 3GPP network side and the UE always detect by polling probabilities of executing “multi-AP connection” LWA operations in an updating manner to make multiple WLAN AP resources on the network side and multiple sets of WLAN function module resources with the LWA capabilities in the UE used as much as possible.

The PAWL and the 1st, 2nd, 3rd, 4th . . . SAWLs correspond to multiple WLAN working links established between the UE and the multiple WLAN APs with LWA capabilities on the network side, and in terms of an establishment sequence, if a condition is met, they may be established at the same time, that is, there is no great difference in the establishment sequence but only a difference in a logical processing sequence.

The PAWL and the 1st, 2nd, 3rd, 4th . . . SAWLs may be established under the same state condition on the basis of strategy criterion parameters and the like corresponding to the same set of LWA mechanism (the 3GPP network side correspondingly configures the same set of strategy criterion parameter and the like to all target APs), and under such a condition, the PAWL and the 1st, 2nd, 3rd, 4th . . . SAWLs have no essential differences (they may all be called as PAWLs), besides different names for convenient description. The PAWL and the 1st, 2nd, 3rd, 4th . . . SAWLs may also be established on the basis of strategy criterion parameters and the like corresponding to different sets of LWA mechanisms (the 3GPP network side correspondingly configures different strategy criterion parameters and the like to different target APs) or under different state conditions, and under such a condition, the PAWL and the 1st, 2nd, 3rd, 4th . . . SAWLs have multiple differences in terms of LWA offloading capability, establishment/maintenance/release and the like, and thus are required to be distinguished more strictly.

Different PAWL and the 1st, 2nd, 3rd, 4th . . . SAWLs independently exist between the multiple WLAN APs on the network side and the multiple sets of WLAN function modules in the UE, so that they may work independently, a change in a working state of any WLAN link may not influence working states of the other WLAN links, and only control of the strategy criterion parameter and the like configured by the 3GPP network side to each WLAN link and influence of the state conditions are considered.

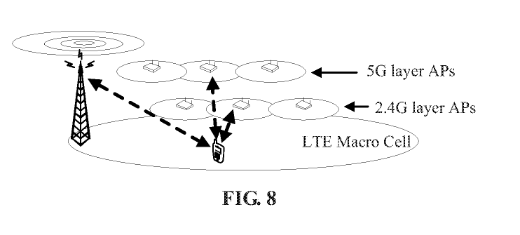

A third embodiment of the disclosure provides a data transmission method. As shown in FIG. 8, a certain operating company deploys an LTE macro cell network to provide basic wireless coverage for a user, and for enhancing a network capacity, the operating company further deploys 40 M-bandwidth WLAN APs to offload and bear IP Flows of a service of the user on certain unlicensed carrier frequency points within unlicensed bands 2.4G and 5G respectively. These WLAN APs all have a capability of executing LWA operations with an anchor MeNB, and there exist standard Xw external interfaces between them and the MeNB. A certain terminal UE1 normally resides in an LTE macro cell, and is kept in an RRC connected state with the MeNB, and meanwhile, the UE1 is also covered by wireless signals of multiple WLAN APs.

In S100, hardware assembled in the UE1 includes: a set of WLAN radio frequency baseband function module A (called as a WLAN module A for short) capable of supporting a 40 M bandwidth of the band 2.4G+ a set of WLAN radio frequency baseband function module B (called as a WLAN module B for short) capable of supporting a 40 M bandwidth of the band 5G, and both of them may execute LWA operations. The UE1 reports RRC information to the MeNB through an LTE air interface, so that an LTE network side acquires a related capability of the UE1 in supporting “multi-AP connection”.

In S101, the MeNB configures strategy criterion parameters related to LWA for the WLAN module A of the UE1 through RRC dedicated signaling, and forms an associated connection at first between a certain node AP1 on the band 2.4G and the WLAN module A in the UE1 according to an existing LWA technical manner under a specific WLAN condition to complete a necessary process of WLAN access authentication and registration and the like, and at this moment, the UE1 obtains an established PAWL. After successful establishment, some IP Flows or IP data packets originally born in the LTE macro cell are offloaded by the PAWL.

In S102, the MeNB further configures strategy criterion parameters related to LWA for the WLAN module B of the UE1 through RRC dedicated signaling, and forms an associated connection between a certain node AP2 on the band 5G and the WLAN module B in the UE1 according to the existing LWA technical manner under a specific WLAN condition to complete the necessary process of WLAN access authentication and registration and the like, and at this moment, the UE1 obtains an established SAWL. After successful establishment, some IP Flows or IP data packets originally born in the LTE macro cell are further offloaded by the SAWL.

It is important to note here that, since a WLAN system adopts a Listen Before Talk (LBT) working manner on the basis of unlicensed radio resource competition at an air interface, the two WLAN modules in the UE1 may not execute operations like LTE carrier aggregation on a vertical plane of a spectrum (the WLAN modules may not align transmission time of multiple data blocks). The UE1 performs WLAN data offloading with two target APs at the same time, which may further enhance a capability of offloading from the LTE macro network to a WLAN and increase data throughput of the user.

In S103, since the UE1 has only two WLAN modules both of which have been used, no more SAWLs may be established.

In S104, although the MeNB temporally detects that all of the WLAN modules in the UE1 have been used, along with movement of the UE and changes of own condition (for example, a signal coverage intensity and quality and a wireless load) of the WLAN, it is also necessary to perform detection by polling to execute “dual-AP connection” in an updating manner (for example, based on a wireless measurement report of the UE1 over a target AP) to make WLAN AP resources on the network side and the two WLAN modules in the UE as much as possible. The target AP nodes of the UE1 within the bands 2.4G and 5G may be independently updated and changed, and specific conditions of the offloaded IP Flows or IP data packets are kept according to the strategy criterion parameters, configured by the MeNB respectively, related to LWA.

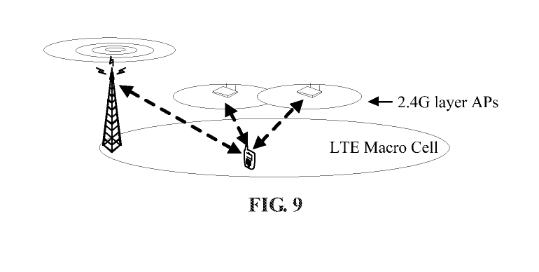

A fourth embodiment of the disclosure provides a data transmission method. As shown in FIG. 9, a certain operating company deploys an LTE macro cell network to provide basic wireless coverage for a user, and for enhancing a network capacity, the operating company further deploys continuous and adjacent 80 M-bandwidth WLAN APs to offload and bear IP Flows of a service of the user on a certain unlicensed carrier frequency point within an unlicensed band 2.4G These WLAN APs all have a capability of executing LWA operations with an anchor MeNB, and there exist standard Xw external interfaces between them and the MeNB. A certain terminal UE2 normally resides in an LTE macro cell, and is kept in an RRC connected state with the MeNB, and meanwhile, the UE2 is also located within overlapped coverage of wireless signals of two adjacent WLAN APs.

In S200, hardware assembled in the UE2 includes: two sets of WLAN radio frequency baseband function modules (called as WLAN modules A/B for short) capable of supporting an 80 M bandwidth of the band 2.4G+ a set of WLAN radio frequency baseband function module C (called as a WLAN module C for short) capable of supporting an 80 M bandwidth of a band 5G, and all of them may execute LWA operations. The UE2 reports RRC information to the MeNB through an LTE air interface, so that an LTE network side acquires a related capability of the UE2 in supporting “multi-AP connection”.

In S201, the MeNB configures strategy criterion parameters related to LWA for the WLAN module A/B of the UE2 through RRC dedicated signaling, and forms an associated connection at first between a certain node AP1 on the band 2.4G and the WLAN module A in the UE2 according to an existing LWA technical manner under a specific WLAN condition to complete a necessary process of WLAN access authentication and registration and the like, and at this moment, the UE2 obtains an established PAWL. After successful establishment, some IP Flows or IP data packets originally born in the LTE macro cell are offloaded by the PAWL.

In S202, an associated connection is further formed between a node AP2 adjacent to the node AP1 on the band 2.4G and the WLAN module B in the UE2 according to the existing LWA technical manner under a specific WLAN condition to complete the necessary process of WLAN access authentication and registration and the like, and at this moment, the UE2 obtains an established SAWL. After successful establishment, some IP Flows or IP data packets originally born in the LTE macro cell and the PAWL may further be offloaded by the SAWL.

It is important to note here that, since a WLAN system adopts an LBT working manner on the basis of unlicensed radio resource competition at an air interface, the AP1 and AP2 on the same WLAN unlicensed working frequency point may not always send data blocks to the UE2 at the same time, and the one successfully preempting a local channel resource may sent the data blocks. The network side may also select the adjacent AP1 and AP2 to bear the same IP Flow content or IP data packet to form a sending and receiving diversity gain.

In S203, although the UE2 still has a set of idle WLAN module C, the network side does not provide a WLAN AP node resource within the band 5G, so that no more SAWLs may be established.

In S204, although the MeNB temporally detects that all of the WLAN modules in the UE2 have been used as much as possible, along with movement of the UE and changes of own condition (for example, a signal coverage intensity and quality, a wireless load and entering coverage of a WLAN node within the band 5G) of the WLAN, it is also necessary to perform detection by polling to execute “dual-AP connection” in an updating manner (for example, based on a wireless measurement report of the UE2 over a target AP) to make WLAN AP resources on the network side and the three WLAN modules in the UE as much as possible. The target AP nodes of the UE2 within the band 2.4G or 5G may be independently updated and changed, and specific conditions of the offloaded IP Flows or IP data packets are kept according to the strategy criterion parameters, configured by the MeNB respectively, related to LWA.

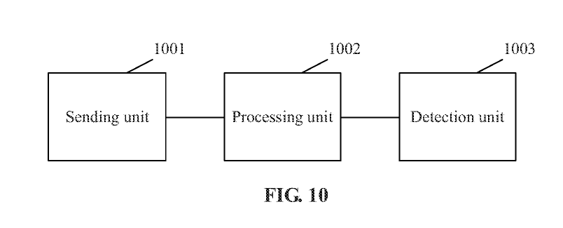

An embodiment of the disclosure provides a terminal, which is applied to a communication system, the communication system further including network equipment, the terminal being provided with at least two WLAN communication elements which support WLAN communication and next-generation WLAN communication respectively. As shown in FIG. 10, the terminal includes a sending unit 1001 and a processing unit 1002.

The sending unit 1001 is arranged to send communication parameters of the WLAN communication elements to the network equipment to enable the network equipment to control the WLAN communication elements to establish at least two AWLs with accessible APs respectively according to the communication parameters.

The processing unit 1002 is arranged to enable the WLAN communication unit to establish the at least two AWLs with the accessible APs under control of the network equipment, where each of the AWLs is arranged to bear data, and each of the AWLs may not only bear the data but also stop bearing the data, and may further be independently maintained, reconfigured and deleted.

In an embodiment, the terminal further includes a detection unit 1003, and the detection unit 1003 is arranged to detect a state of each of the WLAN communication elements in a polling manner, and when it is detected that one of the WLAN communication elements is in an idle or available state, send an AWL establishment request to the network equipment to enable the network equipment to control the WLAN communication element in the idle or available state to establish an AWL with an accessible AP according to the AWL establishment request.

The processing unit 1002 is further arranged to enable the WLAN communication elements to establish the AWLs with the accessible APs under control of the network equipment.

In an embodiment, the WLAN communication elements support an LWA mechanism.

The sending unit 1001 is arranged to report the communication parameters of the WLAN communication elements to the network equipment, for example, an MeNB, as required through LTE or evolved system air interface RRC signaling.

During a practical application, the sending unit 1001 may be implemented by a transceiver in the terminal; and the processing unit 1002 and the detection unit 1003 may be implemented by a Central Processing Unit (CPU), Micro Control Unit (MCU), Digital Signal Processor (DSP) or Field-Programmable Gate Array (FPGA) in the terminal.

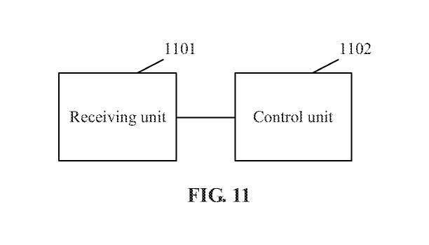

An embodiment of the disclosure provides network equipment, which is applied to a communication system, the communication system further including a terminal, the terminal being provided with at least two WLAN communication elements which support WLAN communication and next-generation WLAN communication respectively. As shown in FIG. 11, the network equipment includes a receiving unit 1101 and a control unit 1102.

The receiving unit 1101 is arranged to receive communication parameters of the WLAN communication elements from the terminal.

The control unit 1102 is arranged to control the WLAN communication elements to establish at least two AWLs with accessible APs respectively according to the communication parameters, where each of the AWLs is arranged to bear data, and each of the AWLs may not only bear the data but also stop bearing the data, and may further be independently maintained, reconfigured and deleted.

In an embodiment, the control unit 1102 is further arranged to control the WLAN communication elements in an idle or available state in the terminal to establish the AWLs with the accessible APs according to an AWL establishment request sent by the terminal, states of the WLAN communication elements being detected by the terminal in a polling manner.

In an embodiment, the control unit 1102 is further arranged to detect the state of each of the WLAN communication elements in the polling manner on the basis of internally stored communication context information of the terminal, and when it is detected that one of the WLAN communication elements is in the idle or available state, control the WLAN communication element in the idle or available state to establish an AWL with an accessible AP.

In an embodiment, the control unit 1102 is arranged to configure strategy criterion parameters related to LWA for the WLAN communication elements in the idle or available state through RRC dedicated signaling;

select the accessible APs according to the received communication parameters of the WLAN communication elements; and

form associated connections between the selected accessible APs and the corresponding WLAN communication elements in the idle or available state respectively, to complete specified WLAN access authentication and registration to establish the AWLs.

In an embodiment, the control unit 1102 is further arranged to coordinate data offloading bearing conditions of the AWLs on the basis at least one of internally stored communication context information parameters or the communication parameters fed back by the terminal to enable the AWLs to bear offloaded data in an independent or collaborative manner.

During a practical application, the receiving unit 1101 may be implemented by a transceiver in the network equipment; and the control unit 1102 may be implemented by a CPU, MCU, DSP or FPGA in the network equipment in combination with the transceiver.

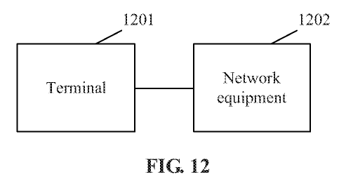

An embodiment of the disclosure provides a communication system. As shown in FIG. 12, the communication system includes a terminal 1201 and network equipment 1202, the terminal is provided with at least two WLAN communication elements which support WLAN communication and next-generation WLAN communication respectively.

The terminal 1201 is arranged to send communication parameters of the WLAN communication elements to the network equipment; and

The network equipment 1202 is arranged to control the WLAN communication elements to establish at least two AWLs with accessible APs respectively according to the communication parameters, where each of the AWLs is arranged to bear data, and each of the AWLs may not only bear the data but also stop bearing the data, and may further be independently maintained, reconfigured and deleted.

In an embodiment, the terminal 1201 is further arranged to detect a state of each of the WLAN communication elements in a polling manner, and when it is detected that one of the WLAN communication elements is in an idle or available state, send an AWL establishment request to the network equipment.

The network equipment 1202 is further arranged to control the WLAN communication element in the idle or available state to establish an AWL with an accessible AP according to the AWL establishment request.

The embodiments of the disclosure relate to an intersystem joint interoperation working mode between cellular mobile systems in a 3GPP system family, for example, an LTE system and a subsequent next-generation cellular system, and WLAN and subsequent next-generation systems, for example, HEW, and particularly relates to a technology of implementing tight coupling data transmission by UE by virtue of “multi-AP connection” under an LWA mechanism. The LTE system includes network-side NW and terminal-side UE, and the WLAN system includes a network side and a terminal side.

In the embodiments of the disclosure, multiple sets of WLAN resource function modules are configured in the UE, where basic function components such as a WLAN radio frequency band a baseband are included. At this moment, under a certain condition, the UE may perform associated connection and data transmission with multiple logically independent WLAN AP nodes served by the network side at the same time to form a “multi-AP connection” working mode. Since physical implementation of the WLAN system requires a far simpler technology and far lower cost than a 3GPP system, configuring the multiple sets of WLAN resource modules may not obviously increase total cost of the UE, and a design manufacturer of the UE may also customize terminals with different 3GPP and WLAN capability module cost proportions according to requirements of operating companies or other industrial users.

From the above, the technical solutions provided by the embodiments of the disclosure may not only reduce control-plane signaling redundancies but also fully utilize network-side resources.

Those skilled in the art should know that: all or part of the steps in the method may be implemented by instructing related hardware through a program, and the program may be stored in a computer-readable storage medium, for example, a read-only memory, a magnetic disk or an optical disk. Optionally, all or part of the steps of the embodiment may also be implemented by one or more integrated circuits. Correspondingly, each module/unit in the abovementioned embodiments may be implemented in form of hardware, and may further be implemented in form of software function module. The disclosure is not limited to a hardware and software combination in any specific form.

Those skilled in the art should know that the embodiment of the disclosure may be provided as a method, a system or a computer program product. Therefore, the disclosure may adopt a form of hardware embodiment, software embodiment and combined software and hardware embodiment. Moreover, the disclosure may adopt a form of computer program product implemented on one or more computer-available storage media (including, but not limited to, a disk memory and an optical memory) including computer-available program codes.

The disclosure is described with reference to flowcharts and/or block diagrams of the method, equipment (system) and computer program product according to the embodiment of the disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

On such a basis, an embodiment of the disclosure further provides a computer storage medium, which includes a set of instructions, the instructions being executed to cause at least one processor to execute the data transmission method for a terminal side or execute the data transmission method for a network equipment side.

It is important to note that the embodiments in the disclosure and characteristics in the embodiments may be freely combined without conflicts. The above is only the preferred embodiment of the disclosure and not thus intended to limit the scope of patent of the disclosure. Any equivalent structure or equivalent flow transformations made by virtue of the contents of the specification and drawings of the disclosure or direct or indirect application thereof to other related technical fields shall fall within the scope of patent protection of the disclosure. Of course, the disclosure may further have various other embodiments, and those skilled in the art may make various corresponding variations and transformations according to the disclosure without departing from the spirit and essence of the disclosure, but these corresponding variations and transformations shall fall within the scope of protection of the appended claims of the disclosure.

1. A data transmission method, applied to a communication system, the communication system comprising a terminal and a network equipment, the terminal being provided with at least two Wireless Local Area Network (WLAN) communication elements which support WLAN communication and next-generation WLAN communication respectively, the method comprising:
sending, by the terminal, communication parameters of the WLAN communication elements to the network equipment; and
controlling, by the network equipment, the WLAN communication elements to establish at least two Aggregated WLAN Links (AWLs) with accessible Access Points (APs) respectively according to the communication parameters.

2. The method according to claim 1, further comprising:
detecting, by the terminal, a state of each of the WLAN communication elements, and when it is detected that one of the WLAN communication elements is in an idle or available state, sending an AWL establishment request to the network equipment; and
controlling, by the network equipment, the WLAN communication element in the idle or available state to establish an AWL with an accessible AP according to the AWL establishment request.

3. The method according to claim 1, further comprising:
detecting, by the network equipment, the state of each of the WLAN communication elements in a polling manner on the basis of internally stored communication context information of the terminal, and when it is detected that one of the WLAN communication elements is in the idle or available state, controlling the WLAN communication element in the idle or available state to establish an AWL with an accessible AP.

4. The method according to claim 1, wherein the WLAN communication elements support a Long Term Evolution (LTE) WLAN Aggregation (LWA) mechanism; and
correspondingly, sending, by the terminal, the communication parameters of the WLAN communication elements to the network equipment comprises:
reporting, by the terminal, the communication parameters of the WLAN communication elements to the network equipment as required through LTE or evolved system air interface Radio Resource Control (RRC) signaling.

5. The method according to claim 4, wherein controlling the WLAN communication elements to establish the at least two AWLs with the accessible APs comprises:
configuring, by the network equipment, strategy criterion parameters related to LWA for the WLAN communication elements in the idle or available state through RRC dedicated signaling;
selecting the accessible APs according to the received communication parameters of the WLAN communication elements; and
forming associated connections between the selected accessible APs and the corresponding WLAN communication elements in the idle or available state respectively, to complete specified WLAN access authentication and registration to establish the AWLs.

6. The method according to claim 1, further comprising:
coordinating, by the network equipment, data offloading bearing conditions of the AWLs on the basis of at least one of internally stored communication context information parameters or the communication parameters fed back by the terminal, to enable the AWLs to bear offloaded data in an independent or collaborative manner.

7. A data transmission method, applied to a terminal, the terminal being provided with at least two Wireless Local Area Network (WLAN) communication elements which support WLAN communication and next-generation WLAN communication; the method comprising:
sending communication parameters of the WLAN communication elements to network equipment to enable the network equipment to control the WLAN communication elements to establish at least two Aggregated WLAN Links (AWLs) with accessible Access Points (APs) respectively according to the communication parameters; and
enabling the WLAN communication elements to establish the at least two AWLs with the accessible APs under control of the network equipment.

8. The method according to claim 7, further comprising:
detecting a state of each of the WLAN communication elements, and when it is detected that one of the WLAN communication elements is in an idle or available state, sending an AWL establishment request to the network equipment to enable the network equipment to control the WLAN communication element in the idle or available state to establish an AWL with an accessible AP according to the AWL establishment request.

9. The method according to claim 7, wherein the WLAN communication elements support an LWA mechanism; and
correspondingly, sending the communication parameters of the WLAN communication elements to the network equipment comprises:
reporting the communication parameters of the WLAN communication elements to the network equipment as required through Long Term Evolution (LTE) or evolved system air interface Radio Resource Control (RRC) signaling.

10. A data transmission method, applied to network equipment; the method comprising:
receiving, from a terminal, communication parameters of at least two Wireless Local Area Network (WLAN) communication elements provided in the terminal, the WLAN communication elements supporting WLAN communication and next-generation WLAN communication; and
controlling the WLAN communication elements to establish at least two Aggregated WLAN Links (AWLs) with accessible Access Points (APs) respectively according to the communication parameters.

11. The method according to claim 10, further comprising:
controlling the WLAN communication elements in an idle or available state in the terminal to establish the AWLs with the accessible APs according to an AWL establishment request sent by the terminal, states of the WLAN communication elements being detected by the terminal.

12. The method according to claim 10, further comprising:
detecting a state of each of the WLAN communication elements in a polling manner on the basis of internally stored communication context information of the terminal, and when it is detected that one of the WLAN communication elements in the idle or available state, controlling the WLAN communication element in the idle or available state to establish an AWL with an accessible AP.

13. The method according to claim 10, wherein controlling the WLAN communication elements to establish the at least two AWLs with the accessible APs comprises:
configuring strategy criterion parameters related to Long Term Evolution (LTE) WLAN Aggregation (LWA) to the WLAN communication elements in the idle or available state through Radio Resource Control (RRC) dedicated signaling;
selecting the accessible APs according to the received communication parameters of the WLAN communication elements; and
forming associated connections between the selected accessible APs and the corresponding WLAN communication elements in the idle or available state respectively to complete specified WLAN access authentication and registration to establish the AWLs.

14. The method according to claim 10, further comprising:
coordinating data offloading bearing conditions of the AWLs on the basis of at least one of internally stored communication context information parameters or the communication parameters fed back by the terminal to enable the AWLs to bear offloaded data in an independent or collaborative manner.

15.-25. (canceled)

26. The method according to claim 1, wherein each of the AWLs is independently maintainable, reconfigurable and deletable.

27. The method according to claim 2, wherein the state of each of the WLAN communication elements is detected by the terminal in a polling manner.

28. The method according to claim 7, wherein each of the AWLs is independently maintainable, reconfigurable and deletable.

29. The method according to claim 8, wherein the state of each of the WLAN communication elements is detected by the terminal in a polling manner.

30. The method according to claim 10, wherein each of the AWLs is independently maintainable, reconfigurable and deletable.

31. The method according to claim 11, wherein states of the WLAN communication elements are detected by the terminal in a polling manner.
